(19) United States
(12) Patent Application Publication
(10) Pub. No.: US 2005/0261969 A1
(43) Pub. Date: Nov. 24, 2005

(54) Layered architecture for POS (point-of sale) systems

(75) Inventors: Boyd K. Dimmock, Raleigh, NC (US); Phuc K. Do, Morrisville, NC (US); Michael J. Johnson, Raleigh, NC (US); E. Michael Maximilien, Raleigh, NC (US); Richard J. Puetzer, Raleigh, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/842,071

(22) Filed: May 10, 2004

(51) Int. Cl. G06F 17/60

(52) U.S. Cl. 705/16

(57) ABSTRACT

Aspects for providing a multi-platform POS (point-of-sale) device driver architecture are described. The aspects include binding an API layer and a transport layer of a POS system with a driver stack, the driver stack supporting multiple platforms, multiple connectivities, and multiple APIs of the POS system.

### FIELD OF THE INVENTION

The present invention related to point-of-sale (POS) systems, and more particularly to a layered architecture for POS systems.

### BACKGROUND OF THE INVENTION

A point-of-sale (POS) system is used in a myriad of retail environments in today's society and includes a variety of hardware components, e.g., typically a host computer, such as a personal computer, to which a display, printer, scanner, cash drawer, card reader, and other input/output (I/O) devices are connected. These devices communicate with the system via a variety of transport connectivities, e.g., USB connections, RS232 connections, RS485 connections, Bluetooth, etc., as is commonly understood. Further, a variety of platforms (or operating systems platforms) are available to use in POS systems, such as Win32 platform (e.g. Windows 98, 2000, XP etc.), Linux and other UNIX flavors, OS4690, etc. Because of shields them from the host computer's specifications and enable a user to deploy a new POS system using existing hardware, as well as to upgrade or expand the hardware without losing compatibility with the POS application. Application development costs can be reduced in turn by such approaches, thereby further reducing the burden on the user and increasing total cost of ownership (TCO). There is also greater flexibility in selecting the hardware, making more options available to the user, i.e., a POS system matching the actual user environment can therefore be built more easily.

In recognition of the needs of the POS environment, a standard was developed, known as UnifiedPOS, that defines compliancy for APIs (application program interfaces) in POS systems. JavaPOS and OPOS are two well-known products that enact or realize this standard UnifiedPOS abstract API. Although the UnifiedPOS standard eases compatibility issues, a problem still exists for POS systems in realizing a unified approach that supports all platforms, all UnifiedPOS APIs, and the various transports for the various devices, while minimizing duplication of common code across the platforms and APIs and maximizing reuse across common code, platforms, and APIs. The present invention addresses such a need.

### SUMMARY OF THE INVENTION

Aspects for providing a multi-platform POS (point-of-sale) device driver architecture are described. The aspects include binding an API layer and a transport layer of a POS system with a driver stack, the driver stack supporting multiple platforms, multiple connectivities, and multiple APIs of the POS system.

Through the present invention, a unified driver stack meets the constraints of the POS environments where there are variations in the UnifiedPOS APIs, in the operating systems platforms, and in the transport connectivities. The unified driver achieves an efficient and effective solution by implementing the semantics of the UnifiedPOS for all devices, by being implemented in a portable software environment (e.g., Java/JVM), by being decoupled from the various device I/O transports and by minimizing the amount of code needed to support new connectivities.

The novel features which are characteristic of the invention, as to organization and method of operation, together with further objects and advantages thereof will be better understood from the following description considered in connection with the accompanying drawings in which one or more preferred embodiments of the invention are illustrated by way of example. It is to be expressly understood, however, that the drawings are for the purpose of illustration and description only and are not intended as a definition of the limits of the invention. These drawings include the following figures, with like numerals indicating like parts.

### BRIEF DESCRIPTION OF THE DRAWINGS

FIG. 1 illustrates a diagram of constraints of a UnifiedPOS environment balanced by a unified driver stack of the present invention.

FIG. 2 illustrates a preferred embodiment of a layered architecture with a unified driver stack in accordance with the present invention.

### DESCRIPTION OF THE INVENTION

The present invention relates to a layered architecture with a unified driver stack for POS environments. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

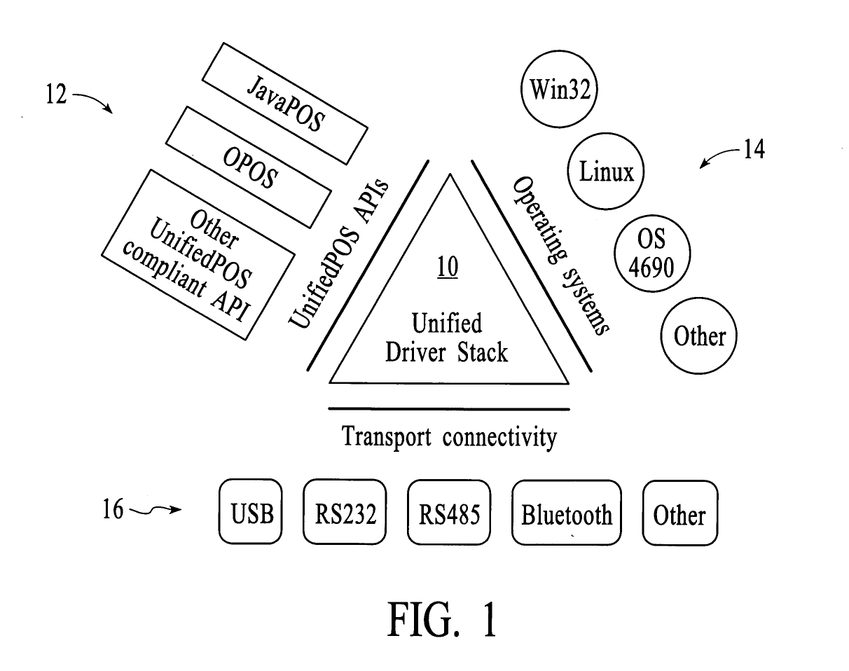

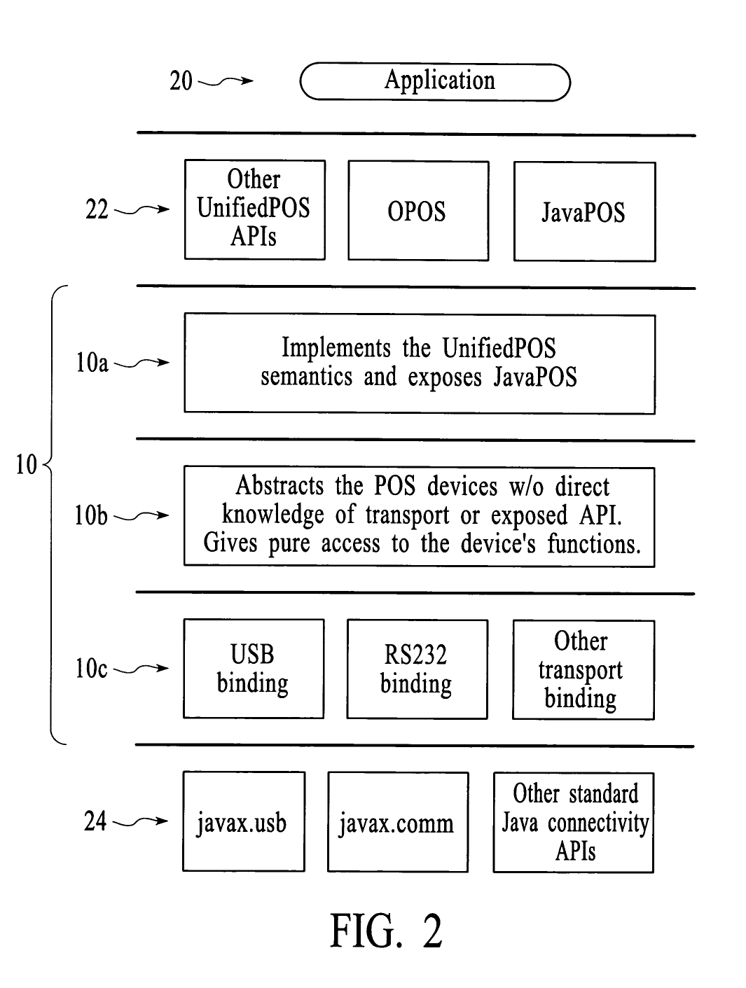

In accordance with the present invention, a unified driver stack is provided that meets the needs and constraints of the UnifiedPOS environment. FIG. 1 illustrates a diagram of these constraints balanced by a unified driver stack 10 of the present invention. The constraints include the variations of the UnifiedPOS APIs 12, operating systems platforms 14, and transport connectivities 16. The unified driver stack 10 meets these contraints by implementing the semantics of the UnifiedPOS for all devices, by being implemented in a portable software environment (e.g., Java/JVM), and by being decoupled from the various device I/O transports, as described in more detail with reference to FIG. 2.

FIG. 2 illustrates a preferred embodiment of a layered architecture with a unified driver stack 10 in accordance with the present invention. In general, the driver stack of the preferred embodiment provides a layered abstraction in JAVA, where the responsibility of each layer is reduced as the layers are viewed from top to bottom. Further, each layer exposes something for the layer above it and expects something from the layer below it. The dependency of the layers is very strict such that a layer only depends on layers below it and exposes functionality on the layer above. A layer never skips to interface a layer not directly adjacent to it.

In order to meet the needs of the retail environment, the layers are chosen such that they can be applied cross-platform, cross-API, and cross-transport with minimal duplication of functionality and ease of future maintenance. Included in the layers is a top-most layer 20 that provides the application program which talks to a next layer 22 of a specific instantiation of the UnifiedPOS API or a UnifiedPOS-compliant API. The UnifiedPOS-compliant API layer 22 binds with the unified driver stack 10. The stack 10 itself is divided into three sections. A first or top section 10a implements the UnifiedPOS semantics and exposes JavaPOS, while being independent of the platform or transport. Thus, the behavior desirable in UnifiedPOS is implemented by this section, e.g., in order to use a device, it needs to be opened, named, enabled, and claimed.

In order to be able to implement the top section 10a, a second or middle section 10b abstracts the POS devices without direct knowledge of the transport or exposed API and gives pure access to device functions. For example, a cash drawer is abstracted as a device that can have a means to open it, close it, and has a state indicative of whether it is open or not. The abstraction of the device functionality in the middle section 10b allows the layer above, section 10a, to send commands to the device as well as receive events and query state information.

With the abstraction of the device by the middle section 10b, the device then needs to be bound to a particular bus. Thus, a third or bottom section 10c provides bindings for the specific supported transport(s). The bindings translate the commands to the specific transport (connectivity) using the appropriate standard or proprietary API. The binding also receives events from the device and forwards these events to the layers above (after first formatting them into the common event description defined in 10b.

For each bus, device API, or connectivity, a standard or proprietary JAVA API in a bottom layer 24 provides the low-level bus connectivity API that exposes that transport to the unified stack 10. Some level of that API (the native) will need to be ported for each OS embodiment, however, this code is minimal, especially when dealing with standard buses. The lowest layer 24 allows the unified stack 10 to easily port to other platforms as well as other transports, since the layer 24 separates the native portion of the bus connectivity APIs from the unified stack 10, and thus, only layer 24 requires alterations to accommodate platform dependent code.

Thus, through the present invention, a unified driver stack meets the constraints of the POS environments where there are variations in the UnifiedPOS APIs, in the operating systems platforms, and in the transport connectivities. The unified driver achieves an efficient and effective solution by implementing the semantics of the UnifiedPOS for all devices, by being implemented in a portable software environment (e.g., Java/JVM), and by being decoupled from the various device I/O transports.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for providing a multi-platform POS (point-of-sale) device driver architecture, the method comprising:
binding an API layer and a transport layer of a POS system with a driver stack, the driver stack supporting multiple platforms, multiple connectivities, and multiple APIs of the POS system.

2. The method of claim 1 wherein the API layer further comprises a UnifiedPOS compliant API layer.

3. The method of claim 1 further comprising layering the driver stack as three sections comprising a top, a middle, and a bottom section.

4. The method of claim 3 further comprising implementing UnifiedPOS semantics and exposing JavaPOS in the top section.

5. The method of claim 4 further comprising abstracting device functionality of POS devices for the POS system in the middle section.

6. The method of claim 5 further comprising binding transports of the POS system in the bottom section.

7. The method of claim 1 further comprising providing the driver stack as a layered abstraction in JAVA.

8. A layered architecture for POS (point-of-sale) environments, the layered architecture comprising:
an application layer;
a UnifiedPOS compliant API layer beneath the application layer;
a driver stack beneath the UnifiedPOS compliant API layer; and
a bus connectivity API layer beneath the unified driver stack.

9. The layered architecture of claim 8 wherein the driver stack further comprises three sections, a top, a middle, and a bottom section.

10. The layered architecture of claim 9 wherein the top section implements UnifiedPOS semantics and exposes JavaPOS.

11. The layered architecture of claim 10 wherein the middle section abstracts device functionality of POS devices for the POS system.

12. The layered architecture of claim 11 wherein the bottom section binds transports of the POS system.

13. The layered architecture of claim 8 wherein the driver stack comprises a layered abstraction in JAVA.

14. A method for providing a multi-platform retail store solution architecture, the method comprising:
providing a layered architecture for POS (point-of-sale) environments; and
including a portable POS driver stack in the layered architecture, wherein the layered architecture can be applied cross-platform, cross-API, and cross-transport with minimal duplication of functionality and ease of future maintenance.

15. The method of claim 14 wherein providing a layered architecture further comprises providing layers that separate applications from UnifiedPOS compliant APIs.

16. The method of claim 15 wherein providing a layered architecture further comprises providing layers that separate UnifiedPOS compliant APIs from the portable POS driver stack.

17. The method of claim 16 wherein providing a layered architecture further comprises providing layers that separate core semantics implementations of the portable POS driver stack from abstract POS devices.

18. The method of claim 17 wherein providing a layered architecture further comprises providing layers that separate the abstract POS devices from transports.

19. The method of claim 18 wherein providing a layered architecture further comprises providing layers that separate the portable POS driver stack from concrete transport connectivity.
